(19) United States
(12) Patent Application Publication
(10) Pub. No.: US 2009/0192994 A1
(43) Pub. Date: Jul. 30, 2009

(54) Self-development apparatus, self-development system, self-development program and computer-readable storage medium for storing self-development program

(76) Inventor: Hidenobu Kawaguchi, Hidaka-gun (JP)

Correspondence Address: WENDEROTH, LIND & PONACK, L.L.P., 1030 15th Street, N.W.,, Suite 400 East, Washington, DC, 20005-1503, US

(21) Appl. No.: 12/318,954

(22) Filed: Jan. 13, 2009

(30) Foreign Application Priority Data
Jan. 25, 2008 (JP) 2008-014352

(51) Int. Cl. G06F 7/06; G06F 17/30

(52) U.S. Cl. 707/3; 707/E17.108; 707/E17.044

(57) ABSTRACT

In the present invention, firstly, some of information on a related personal ideal-state of life is searched via a interactive communication network by using a keyword extracted from among the stored information on a matter of ideal-state of life including that of user's own seeking ideal-state of life in the future, wherein such related personal ideal-state of life is combined with the keyword used in said search of information, on occasion of viewing the user's required relating personal ideal-state-life information, the user can easily obtain the visible and audible such information justly meeting to the user's request, and thereby the user can be enabled to develop one's own latent ability and enhance self-actualizing ability with extreme ease.

### TECHNICAL FIELD OF THE INVENTION

The present invention relates to a self-development apparatus, a self-development system, a self-development program, and a computer-readable storage medium for storing the self-development program.

### BACKGROUND OF THE INVENTION

In contrast with recent rapid advancement in technology due to technological innovation, economic growth, and other factors, personal dreams and hopes have shrunk in comparison with those in old times. Even people who are living in healthy and wealthily associated with a high rank of social position must be unhappy unless having hopes in for future.

However, a person whose circumstances seem unhappy at first glance might still be happy if they lived by imaging what it would be like to realize a dream and with holding a clearly defined goal in one's mind. At the present time, although our lives are apparently provided with far more safety, convenience, and material comfort than in decades and centuries past, these circumstances do not necessarily produce happiness.

Living with holding such dreams and goals as mentioned above in mind in our daily life is extremely important in order to live a more abundant life as a human nature, and in order to make a dream into reality, it is also important to develop one's own latent abilities that have not yet been fully utilized, and to enhance the ability of self-actualization. The mind and body must be kept in a stable state in order to develop latent abilities and enhance self-actualization, and meditation and the like bare effective means for achieving such stability. Such meditative state can be obtained through experience of appreciating a landscape or listening to music or the like that is effective for relaxing the mental state.

Patent document 1 shown hereunder describes a technique relating to a meditation chamber apparatus that is configured so as to create a state of relaxation within an enclosed space that is suitable for

Patent document 1: Japanese Patent Publication No. 2,549,469

Patent document 2 shown hereunder discloses a technique relating to an insurance system for displaying a schedule table to a user and introducing the user to a risk diagnosis and an optimal insurance based on the risk diagnosis on the basis of the schedule input by the user.

Patent document 2: Japanese Patent Publication No. 4,014,401

However, the meditation chamber apparatus according to the Patent document 1 is a room-shaped object in which a closed space is formed, and is extremely large and incapable of producing light meditation. The system disclosed according to the Patent document 2 is a useful means of introducing an insurance commodity, but cannot be used for the purpose of self-development.

The present invention was developed in view of the drawbacks of the prior art described above, and an object of the present invention is to provide a self-development system capable of enabling a user to easily develop one's own potentialities and enhance one's own self-actualization ability, and to provide a self-development apparatus, a self-development program, and a computer-readable storage medium for storing the self-development program.

### SUMMARY OF THE INVENTION

In order to achieve the above-mentioned objects, the self-development apparatus according to a first aspect of the present invention, comprises of an input means for inputting information about a matter of ideal-state of life including that of user's own seeking ideal-state of life in a determined period of time elapsed from the time at present; a storage means; an indication means for indicating information stored in said storage means; an ideal-state information processing means for executing a routine of storing some of ideal-state information input by said input means into an ideal-state information storage section of said storage means; a keyword extraction means for extracting a keyword of searching for a specified some of information from among the stored those in said ideal-state information storage section; a search means for searching of some information about personal ideal-state of life via a communication network by using a certain keyword extracted by said keyword extraction portion; and a data-accumulation means for selecting some of information about a related personal ideal-state of life from among a lot of information collected by means of said search means and accumulating some of relating personal ideal-state-life information in combination with the keyword used in said search of information into a collected-information database storage section of said storage means, wherein under direction of the control unit of the apparatus that some personal ideal-state-life information specified from among the accumulated relating personal ideal-state-life information are to be indicated on said indication means, the specified relating personal ideal-state-life information are read out from the personal ideal-state-life information database storage section and indicated on said indication means.

The self-development apparatus according to the first aspect of the invention, wherein further information about the user's own history of life including that of the user's own seeking ideal-state of life from the expiration of said determined period of time until the user's death is to be input by the input means and stored in a life-history storage section of the storage means by a personal life-history processing means thereof.

The self-development apparatus according to the first aspect of the invention, wherein further some information about a matter of the user's own history of life including that of the user's own seeking ideal-state of life before the determined period of time having been elapsed, are to be input by the input means and stored in a life-history storage section of the storage means by a personal life-history processing means thereof.

The self-development apparatus according to the first aspect of the invention, wherein further information about the user's own history of life from the user's birth up to the present is to be input by the input means and stored in a life-history storage section of the storage means by a personal life-history processing means thereof.

The self-development apparatus according to the first aspect of the invention, wherein further on one occasion of inputting information about the user's own seeking ideal-state of life, information about a video-graphics and music stored in a computer readable medium is to be output and stored into a video-graphics and music database storage section of the storage means.

The self-development system according to another aspect of the invention comprises: at least one or more terminal devices; and a server machine which is connectable to someone of said terminal devices in interactive communicatory via a communication network, wherein each one of said terminal devices has: a first input means for inputting information about a matter of ideal-state of life including that of user's own seeking ideal-state of life in a determined period of time elapsed from the time at present; and a first indication means for indicating information transferred from said server machine via the communication network, said server machine has: a second input means for inputting information about a matter of ideal-state of life including that of user's own seeking ideal-state of life in a determined period of time elapsed from the time at present; a storage means; a second indication means for indicating information stored in said storage means; an ideal-state information processing means for executing a routine of storing some of ideal-state information input by said input means into an ideal-state information storage section of said storage means; a keyword extraction means for extracting a keyword of searching for a specified some of information from among the stored those in said ideal-state information storage section; a search means for searching of some information about personal ideal-state of life via a communication network by using a certain keyword extracted by said keyword extraction means; and a data-accumulation means for selecting some of information about a related personal ideal-state of life from among a lot of information collected by means of said search means and accumulating some of relating personal ideal-state-life information in combination with the keyword used in said search of information into a collected-information database storage section of said storage means, wherein under direction of the control unit of the apparatus that some personal ideal-state-life information specified from among the accumulated relating personal ideal-state-life information are to be indicated on said indication means, the specified relating personal ideal-state-life information are read out from the personal ideal-state-life information database storage section and indicated on said indication means.

The self-development system according to said aspect of the invention, wherein further information about the user's own history of life including that of the user's own seeking ideal-state of life from the expiration of said determined period of time until the user's death is to be input by someone of said first and second input means and stored in a life-history storage section of the storage means by a personal life-history processing portion thereof.

The self-development system according to said aspect of the invention, wherein further some information about a matter of the user's own history of life including that of the user's own seeking ideal-state of life before the determined period of time having been elapsed, are to be input by someone of said first and second input means and stored in a life-history storage section of the storage means by a personal life-history processing portion thereof.

The self-development system according to said aspect of the invention, wherein further information about the user's own history of life from the user's birth up to the present is to be input by someone of said first and second input means and stored in a life-history storage section of the storage means by a personal life-history processing portion thereof.

The self-development system according to said aspect of the invention, wherein further on one occasion of inputting information about the user's own seeking ideal-state of life, information about a video-graphics and music stored in a computer readable medium is to be output and stored into a video-graphics and music database storage section of the storage means.

In the self-development program according to further another aspect of the invention, the program comprises of implementing functional parts:

an ideal-state information processing part which executes a routine of storing some information about a matter of ideal-state of life including that of user's own seeking ideal-state of life in a determined period of time elapsed from the time at present, that is input by an input means on a data inputting step, into an ideal-state information storage section of a storage means;

a keyword extraction part which extracts a keyword to be used to search for a specified some of information from among the stored those in said ideal-state information storage section;

a search part which searches for some information about personal ideal-state of life via a communication network by using a certain keyword extracted by said keyword extraction part;

an accumulation part which selects a specified some of information about a related personal ideal-state of life from among a lot of collected information in the search portion and accumulates some of relating personal ideal-state-life information in combination with the keyword used in said search of information into a collected-information database storage section of said storage means, and

an indication part which indicates information stored in said storage means, wherein under direction of the controlling portion that some relating personal ideal-state-life information specified from among the accumulated relating personal ideal-state-life information are to be indicated on said indication means, the specified relating personal ideal-state-life information are read out from the collected-information database storage section and indicated on the indication means.

Further, in the self-development program according to said aspect of the invention, the program contains such a part that information about the user's own history of life including that of the user's own seeking ideal-state of life from the expiration of said determined period of time until the user's death is to be input by the input means and stored in a life-history storage section of the storage means in a personal life-history processing step.

Further, in the self-development program according to said aspect of the invention, the program further contains such a part that some information about a matter of the user's own history of life including that of the user's own seeking ideal-state of life before the determined period of time having been elapsed, are to be input by the input means and stored in a life-history storage section of the storage means in a personal life-history processing step.

Furthermore, the program further contains such a functional part that information about the user's own history of life from the user's birth up to the present is to be input by the input means and stored in a life-history storage section of the storage means in a personal life-history processing part.

Still further, in the self-development program according to said aspect of the invention, the program further contains such a part that, on one occasion of inputting information about the user's own seeking ideal-state of life, information about a video-graphics and music stored in a computer readable medium is to be output and stored into a video-graphics and music database storage section of the storage means.

In the computer-readable storage medium according to further aspect of the invention, the computer-readable storage medium contains a self-development program for implementing functional parts: an ideal-state information processing part which executes a routine of storing some information about a matter of ideal-state of life including that of user's own seeking ideal-state of life in a determined period of time elapsed from the time at present, that is input by an input means connected with the related computer on a data inputting step, into an ideal-state information storage section of a storage means; a keyword extraction part which extracts a keyword to be used to search for a specified some of information from among the stored those in said ideal-state information storage section; a search part which searches for some information about personal ideal-state of life via a communication network by using a certain keyword extracted by said keyword extraction part; an accumulation part which selects a specified some of information about a related personal ideal-state of life from among a lot of collected information in the search portion and accumulates some of relating personal ideal-state-life information in combination with the keyword used in said search of information into a collected-information database storage section of said storage means, and an indication part which indicates information stored in said storage means, wherein under direction of the controlling portion that some relating personal ideal-state-life information specified from among the accumulated relating personal ideal-state-life information are to be indicated on said indication means, the specified relating personal ideal-state-life information are read out from the collected-information database storage section and indicated on the indication means

In the present invention, since some of information about a related personal ideal-state of life-is searched via a communication network by using a keyword extracted from among the stored information about a matter of ideal-state of life including that of user's own seeking ideal-state of life in the future, in which such related personal ideal-state of life is combined with the keyword used in said search of information, on occasion of viewing the user's required relating personal ideal-state-life information on the indication means, the user can easily obtain the visible and audible personal ideal-state-life information justly meeting to the user's request, and thereby the user can be enabled to develop one's own latent ability and enhance self-actualizing ability with extreme ease.

In the invention, further information about the user's own history of life including that of the user's own seeking ideal-state of life from the expiration of said determined period of time until the user's death is to be input by the input means and stored in a life-history storage section of the storage means by a personal life-history processing portion, whereby the user is enabled to more clearly envision and recognize one's own seeking ideal-state of life after the determined period of time elapsed. Accordingly, the user can easily develop in one's own latent ability and enhance self-actualizing ability, lead a good life with dreams and hopes every day, and be doing one's best to encourage towards self-development.

In this invention, further, some information about a matter of the user's own history of life including that of the user's own seeking ideal-state of life before the determined period of time having been elapsed, are to be input by the input means and stored in a life-history storage section of the storage means by a personal life-history processing portion, whereby the user can be allowed to more clearly recognize what his efforts must be directed toward, and the user can be helped to work towards self-development by causing the user to input what his efforts must be directed toward until the determined period of time has been elapsed.

Furthermore, in this invention, information about the user's own history of life from the user's birth up to the present is to be input by the input means and stored in a life-history storage section of the storage means with a personal life-history processing portion, whereby the user can pass one's life in review, assess past problems in one's personal history, and overcome user's own problems. Resultantly, the user is brought up under a stable state in body and mind.

Still further, when the user inputs information about a matter relating to the user's own seeking ideal-state of life by using the input means, information about a video-graphics and music stored in a computer readable medium is to be output and stored into a video-graphics and music database storage section of the storage means, thereby the user is enabled to more easily concentrate one's own vitalities and to input information relating to a higher ideal state, and resultantly the user is made to experience a meditative state with extreme ease.

### BRIEF DESCRIPTION OF THE DRAWINGS

FIG. 1 is a block diagram showing the computer of the self-development apparatus according to an embodiment of the present invention;

FIG. 2 is a flowchart showing the self-development program;

FIG. 3 is a diagram showing the overall structure of the self-development system according to an embodiment of the present invention; and

FIG. 4 is a functional block diagram showing the server and terminal device of the self-development system.

### DETAILED DESCRIPTION OF THE PREFERRED EMBODIMENTS

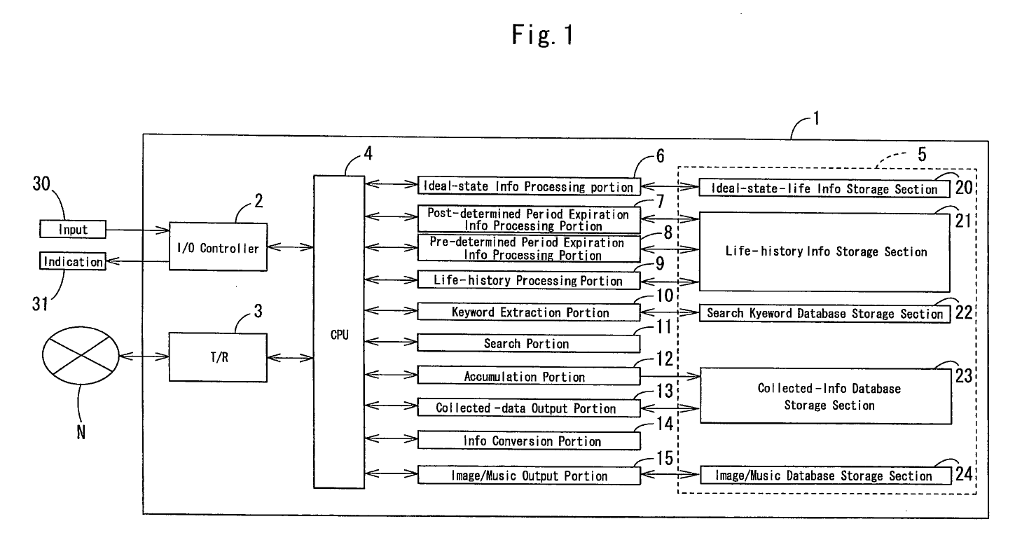

A preferred embodiment of the present invention will be described based on the accompanying drawing. FIG. 1 is a block diagram showing the computer, for example, a personal computer that constitutes the self-development apparatus. The self-development apparatus 1 provides with various peripheral equipment, exemplarily, an external input means 30 for inputting data by using, for example, a keyboard, a mouse, a numeric pad or the like; and an external indication means 31 for visually or aurally indicating information containing images, illustrations, graphics, music or the like, by using, for example, an LCD, CRT, or other display, printer, audio-appliances and the like. The self-development apparatus 1 comprises an input/output control portion (I/O controller) 2 for controlling data that are output from/input into a central processing unit (CPU) 4; and a hard disk, ROM, RAM, or other storage device 5 for storing data, various kinds of program including a main application program for self-development according to the invention.

The self-development apparatus 1 is also connected to an Internet, intranet, or other communication network N by an interactive communication portion 3. Various types of data bases are stored into the storage or memory device 5 of the apparatus 1. These data bases may not necessarily be provided within the storage device 5 of the relevant self-development apparatus 1, or otherwise within such storage device of other apparatus that is connected via the communication network N and capable of accessing the relevant apparatus 1.

Various kinds of programs are stored in the storage device 5 of the self-development apparatus 1, and many kinds of information processing procedures follow along the self-development program specified from among the stored programs. The self-development program for handling of those information processing is to operate an ideal-state information process portion 6, a post-determined period expiration information processing portion 7, a pre-determined period expiration information processing portion 8, a life-history processing portion 9, a keyword extraction portion 10, a search portion 11, an accumulation portion 12, a collected data output portion 13, an information exchange portion 14, and an image/music output portion 15. The storage device 5 is also provided with an ideal-state information storage section 20, a life history information storage section 21, a keyword candidate database storage section 22, a collected information database storage section 23, and an image/music database storage section 24.

The ideal-state information processing portion 6 executes a routine for storing such information that are input with operating the input means 30 into an ideal-state information storage section 20, someone of which are information about a matter of ideal-state of life including that of user's own seeking ideal-state of life in a determined period of time elapsed from the time at present. When the CPU 4 provides onto the ideal-state information processing portion 6 with direction that some personal ideal-state-life information specified from among the accumulated personal ideal-state-life information are to be indicated on the indication means 31, the specified personal ideal-state-life information are read out from the personal ideal-state-life information database storage section 23 and output to the indication means 31.

The post-determined period-expiration information processing portion 7 executes a routine for storing such information that are input with operating the input means 30 into a life-history information storage section 21, someone of which are information about the user's own history of life including that of the user's own seeking ideal-state of life from the expiration of said determined period of time until the user's death, that is so called briefly as post-determined period expiration information hereunder. When the CPU 4 provides onto the post-determined period-expiration information processing portion 7 with direction that some post-determined period expiration information stored in the life-history information storage section 21 are to be indicated on the indication means 31, such post-determined period expiration information are read out from the life-history information storage section 21 and output to the indication means 31.

The pre-determined period-expiration information processing portion 8 executes a routine for storing such information that are input with operating the input means 30 into said life-history information storage section 21, someone of which are information about a matter of the user's own history of life including that of the user's own seeking ideal-state of life before the determined period of time having been elapsed, that is so called briefly as pre-determined period expiration information hereunder. When the CPU 4 provides onto the pre-determined period expiration information processing portion 8 with direction that some pre-determined period expiration information stored in the life-history information storage section 21 are to be indicated on the indication means 31, such pre-determined period expiration information are read out from the life-history information storage section 21 and output to the indication means 31.

The personal life-history processing portion 9 executes a routine for storing such information that are input with operating the input means 30 into said life-history information storage section 21, someone of which are information about the user's own history of life from the user's birth up to the present, that is so called briefly as personal life-history information hereunder. When the CPU 4 provides onto the personal life-history processing portion 9 with direction that some personal life-history information stored in the life-history information storage section 21 are to be indicated on the indication means 31, such personal life-history information are read out from the life-history information storage section 21 and output to the indication means 31.

The keyword extraction portion 10 extracts information used as a keyword of searching for a specified some of information from among the stored those in said ideal-state information storage section 20.

The search portion 11 searches for some information about personal ideal-state of life, that is so called as relating personal ideal-state-life information hereafter, via the communication network N by using a certain extracted keyword in the keyword extraction portion 10.

The accumulation section 12 selects a specified some of information about a related personal ideal-state of life from among a lot of collected information in the search portion 11 and accumulates some of relating personal ideal-state-life information in combination with the keyword used in said search of information into a collected-information database storage section 23 of said storage means 5.

The collected data output portion 13 outputs instructed ideal-state-related information to the indication means 31 under direction that some specified relating personal ideal-state information are to be indicated on the indication means 31, such specified relating personal ideal-state-life information are read out from the collected-information database storage section 23 and output to the indication means 31.

The information exchange portion 14 performs communication processing in order for a plurality of users to exchange opinions on a bulletin board or the like, for example, via the communication network N.

The image/music output portion 15 outputs some information about a video-graphics and music stored in a computer readable medium and stores those into a video-graphics and music database storage section 24 when some information about the user's own seeking ideal-state of life is input by using the input means 30.

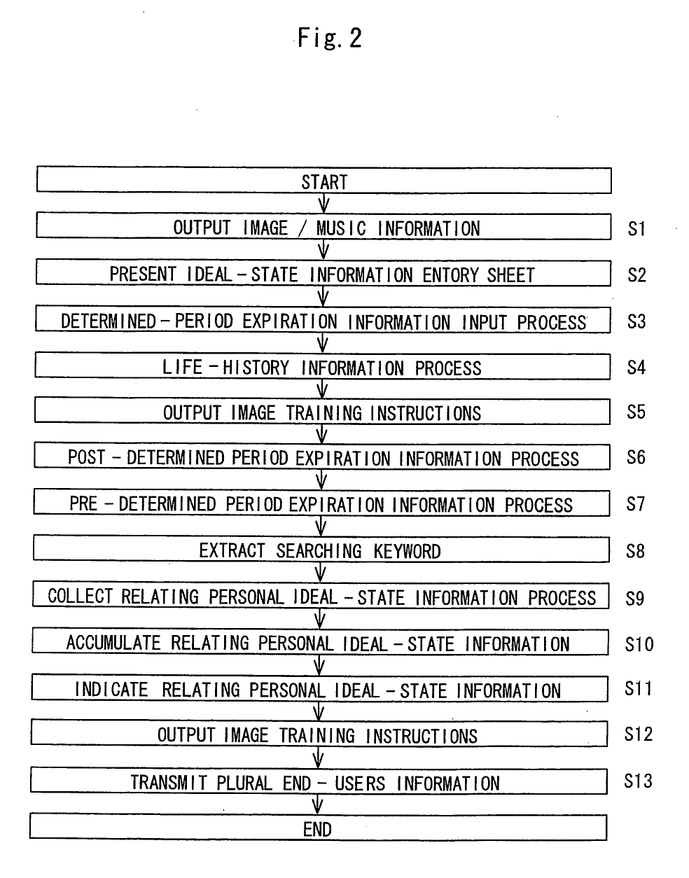

Next, the sequence of information processing using the self-development apparatus 1 are illustrated in detail. FIG. 2 is a flowchart showing the self-development program according to the present embodiment.

First, in step S1, on the occasion of inputting information about the user's own seeking ideal-state of life by using the input means 30, the image/music output portion 15 outputs some information about a video-graphics and music stored in a computer readable medium (not shown) or an image/music database storage section 24. This storage medium is not limited to a hard disk or other internal storage means, and may also be a portable external storage means.

In the medium, some information about some video-graphics, images, characters, music and the like depicting concretely ideology or philosophy that are effective for creating and actualizing user's seeking ideal state of life in the future, are stored in advance. Accordingly, the user can easily be enabled to focus his energy by appreciating and comprehending the images and music. In addition to the items described above, the storage medium also stores information relating to images, characters, video, or music that clearly and specifically depict simple yoga exercises as well as a breathing exercise, meditation method, ocular exercises, image training, and the like described hereinafter.

The above-identified images and music include, for example, animation video illustrating the Buddhist principle of karma, in which the origin of phenomena experienced at present is the outcome of some deeds in former times, the concept of the oneness of life and the environment in which the self and the environment are inseparably related to each other, that is, the causes of events in the future exist in the present, or the like. Video graphics of instructor imitating a person, animal, robot, or the like which are produced by using computer graphics is transferred to the indication means 31, and the instant video of instructor is to explain to the user what is necessary for progressing in the user's self-development and enhancement of one's actualization and what is important in judging of a thing's worth. The user can choose the user's favorite type of instructor from a plurality of candidates. In such a way, it is preferable for users to arise much interest in subsequent operations and put everything them thereunto to be enabled to smoothly make much progress in one's self development. Furthermore, it is preferable to provide the users with such instructors that advise them to perform each demanded operation in the subsequent steps as well as offer various type of illustration in each of subsequent steps.

In step S2, the ideal-state information processing portion 6 outputs a video recording of an instructor together with an ideal-state information entry sheet to the indication means 31 and then the instructor advise the user's entering the ideal-state information after a certain determined period of time from now into the entry sheet. According to this demand, the ideal-state information including information relevant to the user's own ideal-state of life having been entered with the user's operation of the input means 30 after a determined period of time elapsed from the time at which the user entered a required ideal-state information before, is stored into the ideal-state information storage section 20 by the ideal-state information processing portion 6 (step S3).

As the determined period of time with regard to the ideal-state information of the present embodiment, for example, may be employed six months, five years, 10 years, 20 years, 30 years, or the like may be employed. The length of the period of time is not necessarily limited thereto, but rather in a certain period of time. Besides, as such determined period of time, a well definable period of time is preferred, because the user can then easily and clearly imagine the user's future. Such a determined duration is, for example, from an entry of an ideal-state information with the input means 30 up to that time elapsed, such as six months, five years, ten years, 20 years, 30 years or the like.

Examples of the information relating to the user's own ideal-state of life include the user's hopes to attain in future to the user's own occupation, family life, health, mental state, economic state, interests and otherwise it may be a simple goal or the like, but it would be much preferable to such information related to a dream that supposed to be probably impossible to carry out. As such information, there is one related not only to the user itself, but also to the state in future desired for the user's family, friends, acquaintances, coworkers, and other individuals. Further, as such information, the ideal-state information in the past, for example, ten years from now would be available in which the ideal-state information may be numerically indicated with the improvement rate or progress rate by comparison with numerical values indicating annual income, health status, mental state, and other characteristics at present.

In such numerical calculation and arithmetic operation of the progress rate or the like, the progress rate or improvement rate may be expressed in the standard of the time at present, or otherwise it may be described in the standard of an ideal-state after a determined period of time in comparison with an imaginary ideal-state apart from the ideal-state at present. In such a way, the user of its self can be allowed to precisely recognize an ideal-state in the future by a numeric information with respect to an ideal-state in the future which is somewhat far remote from those in the present rather than setting a goal or designing a life in the future by employing an ordinary method for predicting one's own life in the future in extent in the range of the past and present. As a result, the user can also create one's own life in the future that is entirely distinguished from ones in the present, and therefore, the user's abilities that have not been adequately utilized until the present time can be used to the greatest extent possible.

By thus allowing the user to use characters or numeric values to clearly imagine and envision the ideal-state at the time when a prescribed time has elapsed, the user can be made aware of just what must be done from now on in order to actualize the ideal-state, and the user can be encouraged towards self-development. It is generally difficult for people to accept advice from another person 100%, and there is a mentality that will reject part of the other person's advice concerning an area that the person being given the advice does not notice in himself. Therefore, when the user advises himself towards one's own enhancement of self-actualizing ability, self-development can be achieved with higher effectiveness.

The ideal-state information entry sheet is to be filled in with the following information, for example, with respect to general private user's own affairs, the user's age at a determined expiration period of time, health status, mental state, interests, and the like are freely entered, with regard to the user's job affairs, working status, work level, service contents, and the like being entered. In similar way, with respect to the user's family affairs, age, appearance, health status, interests, and other ideal-states according to the user's life partner, children, farther, mother, pets, and other family members are also entered. Further, friends, acquaintances, and others may be entered. Furthermore, regarding the ideal-state information, each progress rate of the respective items since then may be numerically indicated by numeric values, for example, from 100 to 300.

In step S4, a chronological table type of entry sheet for entry of information relevant to the history from the user's birth up to the present is output to the indication means 31 by the history processing portion 9, and then the relevant instructor appeared on the screen of the indication means 31 advises that the entry sheet must be entered with the user's life history affairs. According to the instructions issued from the instructor, when the chronological table type of entry sheet having been entered with the required information of the user's life history, these are transferred advised to issues output for performing a display in which the instructor prompts input. This chronological entry sheet is used by the user to input the history information from birth to the present time according to the instruction of the instructor, for example, and the history processing portion 9 thereby executes a routine for storing the input information in the life history information storage section 21.

The chronological table type of entry sheet for the information relating to the user's history of life from birth up to the present is filled in with, for example, dating of the dominical year, ages of the user and its families, yearly income, etc. and the history of the user himself or his family for each year is freely recorded. The user also decides on and inputs a theme for each determined period such as five years, for example, from the input history. The user can thereby more easily reevaluate the time from past to present, and the user himself can thus be helped to easily understand that his present form is a result of one's own accumulated choices from the past. Emergence, character formation, curiosity, or the like, for example, may be freely determined as the theme.

The history processing portion 9 furthermore issues an output on the screen of the indication means 31 in which the instructor explains and instructs according to a self-observation method or the like in which the user is instructed to repeatedly recall the three themes of deeds received, deeds repaid, and inconvenience caused in the user's relationship with father, mother, siblings, and other people close to him until the present time. The user can thereby see and hear the output content and easily obtain self-insight merely by ruminating on the displayed output, and can deepen understanding and trust of self and others, realize one's own existence value and responsibility, and work towards self-development.

In step S5, the image/music output portion 15 issues output in which the instructor gives instruction to the user to perform ocular training, a breathing exercise, image training, or the like as psychological and physical training effective for activating subconscious awareness, for example, in the indication means 31 when the post-determined period-expiration information and pre-determined period-expiration information are input in the subsequent steps S6 and S7. Causing the user to concurrently perform these various types of training helps the user to specifically and clearly envision one's own future state. Instead of envisioning the future as an extension of the past and present, the user can easily comprehend the possibility of actually creating his ideal self according to his present choices.

The ocular training in the psychological and physical training given by the instructor involves extending both hands in front of oneself, placing both palms so as to face the body, and placing the tips of the fingers opposite each other while separating the fingers of both hands a prescribed width apart. A position is then assumed in which a line running through the hands, arms, and shoulders forms a substantially triangular shape in a plane. While breathing comfortably, the user moves his line of sight as rapidly as possible so as to look in zigzag fashion at the fingertips of the left thumb, right thumb, left index finger, right index finger, left middle finger, right middle finger, and so on. This is done in a manner in which breathing and movement of the line of sight can be done in the same rhythm. The person then closes his eyes for about 30 seconds, contemplates the self at and until the present time, and confirms one's own future image or the like.

In the breathing exercise, the person sits in a chair in a relaxed manner, extends the spinal column, places one hand palm-upward on each knee, and forms a ring with the tips of each thumb and forefinger. Abdominal breathing is performed by lowering the diaphragm when breathing in, and raising the diaphragm when breathing out. This state is maintained for about one minute, after which the person closes his eyes and contemplates and recognizes one's own senses, the experience in his body and mind, and the like.

The image training involves, for example, assuming the posture of the previously described breathing exercise, and while closing the eyes, imagining in detail such scenes as a large ship moving from left to right on the open sea (simple movement method), an automobile or airplane coming toward oneself and then passing by (distance movement training), numerous people walking toward oneself (parallel movement method), or the like. The simple movement method enables the person to acquire a sense of distance or coordinate positioning within the mind, the distance movement training enables the person to be aware of the area of one's own field of view, and the parallel movement method enables a shift of consciousness from linear to planar.

The training methods described above are found in Masahiro Kurita's Super Reading System instructional book published by See Corporation, but the present invention is not limited by these methods, and other training methods may also be used.

In step S6, the post-determined period-expiration information processing portion 7 outputs to the indication means 31 the chronological entry sheet for inputting progression information for the period until death after the ideal-state information of the time when the determined period has passed input in step S3 has been achieved, and output is issued in which the instructor gives instructions prompting input. The sheet is in the same format as the sheet displayed by the history processing portion 9 in step S4, and half the sheet is used thereafter.

According to the instructions of the instructor, the user is caused to imagine and input to the sheet the information relating to the ideal-state from after the determined period has passed until the user's age of death using the reference of the ideal-state information of the time when the determined period has passed that was stored in the ideal-state information storage section 20 by the ideal-state information processing portion 6, and the post-determined period-expiration information processing portion 7 then executes a routine for storing the post-determined period-expiration information in the life history information storage section 21.

In step S7, the pre-determined period-expiration information processing portion 8 outputs to the indication means 31 a chronological entry sheet for inputting some information about a matter of the user's own history of life including that of the user's own seeking ideal-state of life before the determined period of time having been elapsed, that is called in a simple words “pre-determined period expiration information”, and simultaneously a video tape recording of an instructor which calls upon the relevant user to input such information as described above. According to such directions, the user sets up a schedule to achieve user's own seeking ideal state of life within the expiration of the determined period of time, and inputs into the entry sheet such pre-determined period expiration information and then such information, and then the pre-determined period-expiration information processing portion 8 executes a routine for storing the pre-determined period-expiration information in the life-history information storage section 21 of the storage device 5.

In step S8, the keyword extraction portion 10 extracts such characters, numbers, symbols, pictures, and other information that can be used as a keyword of searching for a specified some of information from among the information on a matter of user's own seeking ideal state of life stored in the ideal-state information storage section 20. In an example of the method for extracting keywords, several candidates such as “overseas travel,” “my home,” “dog,” and the like are accumulated in advance in the prescribed keyword candidate database storage section 22, and a priority order is attached to each candidate, and when a character that corresponds to a candidate is input, the character is extracted in accordance with the priority order. The user himself may also extract the keyword.

In step S9, the search portion 11 executes a routine in which the keyword extracted by the keyword extraction portion 10 is used to search for some information about personal ideal-state of life, which is information relating to the ideal-state, from a web page or the like via the communication network N. The above-identified information about personal ideal-state of life is so called as a relating personal ideal-state-life information hereunder. A publicly known method is used to search for some of relating personal ideal-state-life information, and various types of search engines are used to collect such relating personal ideal-state-life information, which includes web pages containing such keywords therein, or images, video, music, characters, descriptions, and other information placed in a web page.

In step S10, when the control unit of the apparatus 1 provides to the user a direction of that a specified relating personal ideal-state-life information is to be selected from the relating personal ideal-state-life information collected in the collected-information database storage section 23, some of the specified relating personal ideal-state-life information by the search portion 11 in combination with the keyword used in the information search are stored in the collected-information database storage section 23.

In step S11, under direction of the control unit of the apparatus 1 that the specific ideal-state-related information from among the ideal-state-related information stored in the collected information database storage section 23 is to be read out from the collected information database storage section 23 and output to the indication means 31, some of the directed relating personal ideal-state-life information are read out through the collected data output portion 13 from the collected information database storage section 23 and output to the indication means 31 via the communication network N to be indicated thereon. In this case, it may be adopted such a configuration that the relating personal ideal-state-life information in corresponding to the direction each time of issuing such direction may be read out from the collected information database storage section 23 as well as output to the indication means 31. Also, it may be adopted such a configuration that a plurality of the stored relating personal ideal-state-life information in combination with the extracted search-keyword is continuously read out from the collected information database storage section 23 as a sequence of slides when the keyword is selected.

On the occasion of reading out someone of the specified relating personal ideal-state-life information from the collected-information database storage section 23 and transferring those onto the indication means 31 at a determined time everyday, simultaneously or a short time after or before its occasion, a certain entry sheet filled with some of information about a mater of ideal-state of life stored onto the ideal-state information storage section 20 in Step 3 may output onto the indication means 31.

By viewing the entry sheet filled with one's own seeking ideal-state of life information indicated onto the indication means 31 daily, the user is prevented from forgetting his goals for the future, and the goals can be fixed in the user's subconscious awareness.

In step S12, on a certain occasion of indicating the specified relating personal ideal-state-life information, simultaneously, a while before or after its occasion, or at an appropriate other time, some of the specified image/music information including a video-instructor which instructs about the simple yoga exercises, breathing exercises, meditation exercises, ocular exercises, image training, and the like are read out from the image/music database storage section 24 or other storage medium by the collected data output portion 13 and indicated onto the indication means 31 to be prompt in executing these actions.

By following direction of the instructor, the users are easily enable to execute the various exercises and trainings. Accordingly, the users can activate user's own powers of imagination and their own potentialities and latent resources. Resultantly, the users can strengthen user's own brain power and activate their body, mind and spirit, whereby it helps the users to enhance the user's motivation for self-actualization and ability to achieve goals. Besides, such indication of video-instructor in step S12 does not necessarily have to be performed, and may be omitted.

In step S13, the information exchange portion 14 executes a routine in which communication is performed via the communication network N from the communication section 3, a screen in output to the indication means 31 in order for the opinions of a plurality of users using the self-development apparatus 1 of the present invention to be input and output, and information is exchanged between users. Each user can thereby identify with other people who, like themselves, are working towards enhancing latent abilities or enhancing self-actualizing ability, and the users' motivation to achieve their goals can be further enhanced. Interactive development between a plurality of users is also made possible.

Self-development using the self-development program according to the present embodiment may also be performed in conjunction with direct instruction by a business person with a record of achievement in developing abilities, or a leader who belongs to a group or the like. A synergistic effect is thereby added that dramatically enhances self-development.

In steps 1 through 13, each routine need not be performed in the same order as described above, the sequence of steps may be switched, and prescribed steps may be omitted. It is also possible to add steps for executing other routines that are anticipated to have an effect on self-development.

As described above, since information that can be effectively utilized for self-development can easily be collected, accumulated, and output, the user can easily be enabled to enhance his latent abilities, enhance self-actualizing ability, and develop the self.

Furthermore, when the self-development apparatus according to the present embodiment is utilized in organizational operations such as companies, localities, and the like, not only can the latent abilities and self-actualizing ability of individual users be enhanced, but the capability of the organization as a whole can also be enhanced. In business management settings, mission statements are drafted, mid to long-term business plans are formulated, various types of mental training, and various other efforts are generally made, but effects sometimes do not improve according to the skills of the manager. Therefore, by utilizing the self-development apparatus of the present embodiment in an organizational manner, the abilities of the individuals making up the organization can be enhanced, and the capability of the company, enterprise, local government, or other organization can thereby be enhanced.

Seminars, counseling, and the like are cited as examples of ways in which the self-development apparatus 1 of the present embodiment is used in an organizational operation. In the self-development apparatus 1, a paper medium may be used jointly with input using the ideal-state information entry sheet, the chronological entry sheet for inputting progression information, and the like. In this case, the items of information input in the paper sheet are converted to image information by a scanner or the like without modification, or are stored in the storage device 5 after being converted to digital data. A paper, sound, or video medium may also be used jointly with the output and the like of the image/music output portion 15.

In the embodiment described above, the self-development program was stored in a dedicated storage device 5 in the self-development apparatus 1, but the self-development program of the present invention is not limited by this configuration, and may be composed of a computer-readable storage medium, or may be downloadable via a communication network. The self-development program may also be made usable by a device exclusively used for games.

The self-development program may also be stored in a storage device of a server and configured as a self-development system in which the routines for self-development of the user are executed by communicating information via a network with a terminal device operated by the user.

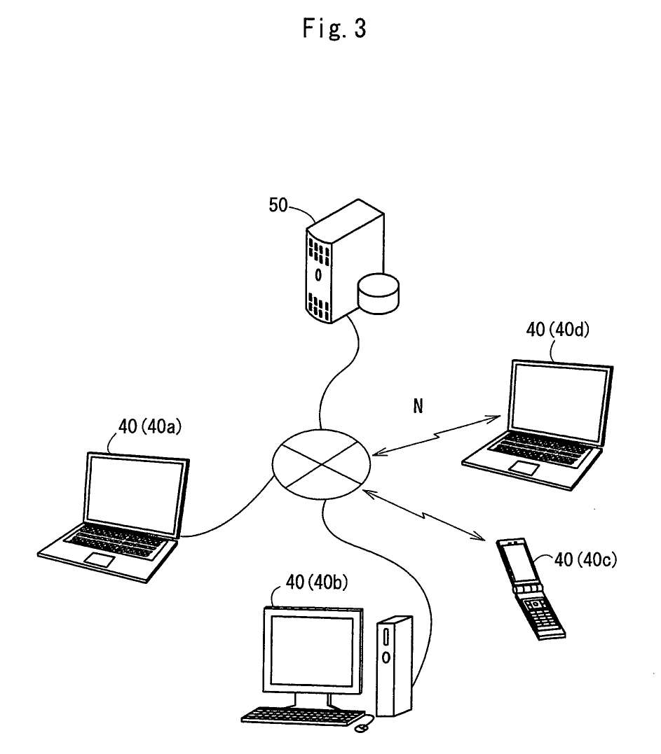

FIG. 3 is a diagram showing the overall structure of such a self-development system. In the self-development system, someone of a server machine 50 and a terminal device 40 (40a, 40b, 40c, 40d) operated by a user are connected to each other via the Internet or another communication network N.

The above-mentioned terminal device 40 is not particularly limited insofar as the terminal device is capable of communicating with the server machine 50 via the interactive communication network N, and may be a type of portable communication terminal device or the like such as a multi-purpose personal computer 40a, 40b, a mobile telephone 40c or PHS, or a so-called mobile personal computer 40d. The number of terminal devices 40 is also not particularly limited, and means for the connection between the server machine 50 and the terminal devices 40 is not limited to wires, and may, of course, be a wireless connection. Besides, the terminal device 40 includes external types of first input means 41 and first indication means 42, the former being useable of the same one of the input means 30, the later being useable of the same one of the indication means 31. Also, in a similar way, the server machine 50 includes external types of a second input means (not shown) and a second indication means (not shown).

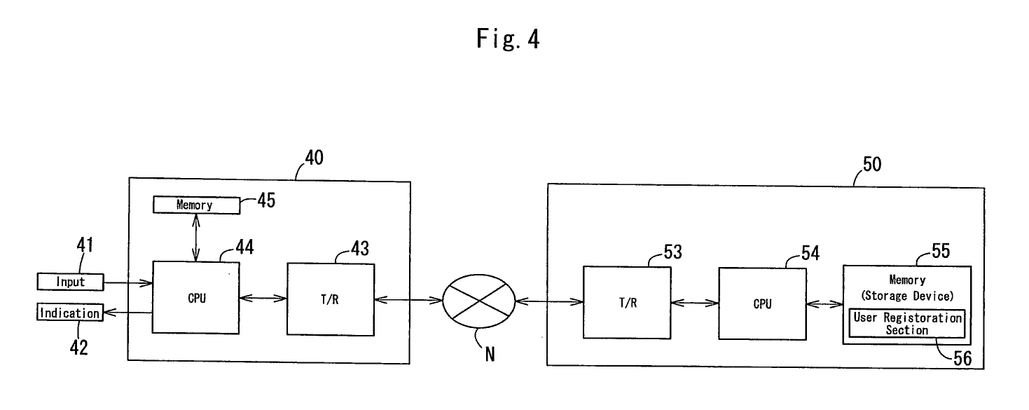

FIG. 4 is a functional block diagram showing the schematic structure of the server machine 50 and the terminal device 40. By using someone of the first input means 41 of the terminal device 40 and the second input means connected to the server machine 50, in a similar way, the ideal-state information, the post-determined period-expiration information, the pre-determined period-expiration information, the information relating to history, and other various types of information are input, and an indication means 42 outputs various types of information including the ideal-state-related information transmitted from the server 50 via the interactive communication network N. A communication portion (or Transmitter/Receiver) 43 of the terminal device 40 transmits or receives data to or from the server 50 via the communication network N, and a computation portion 44 (or Central Processing Unit CPU) of the terminal device 40 executes a routine or programmed sequence stored in a storage device 45.

A communication section 53 of the server machine 50 transmits and receives data with the terminal device 40 connected via the communication network N, and when the ideal-state information, the post-determined period-expiration information, the pre-determined period-expiration information, the information relating to history, and other various types of information sent from the terminal device 40 are received by the communication section 53, the computation section 54 of the server machine 50 executes routines in the same manner as the computation section 4 of the self-development apparatus 1 described above on the basis of the self-development program stored in the storage device 55 for each item of information. The communication section 53 of the server machine 50 then transmits the ideal-state-related information and other information to the terminal device 40 via the communication network N.

Regarding the communication between the server machine 50 and the terminal device 40 in the self-development system, encryption processing is preferably applied to the data for transmission and reception, or a function for maintaining secure communication is preferably provided to both the server machine 50 and the terminal device 40.

In addition to the components provided to the above-mentioned self-development apparatus 1, the server machine 50 is furthermore provided with a user registration section 56 for identifying users who operate the terminal device 40 and communicate information, and registering the users in a database, and processing is performed in the user registration section 56 to manage each item of information together with a registration ID, a password, and the like for each user.

The storage device (or memory device) 5 has an ideal-state information storage section 20, a life-history information storage section 21, a search-keyword database storage section 22, a collected information database storage section 23, and an image/music database storage section 24, and these memory sections (or areas) are managed by the control unit of the server machine 50, and may be configured so as to be managed by the server machine 50 as information stored in an external storage section of another terminal device that can communicate via the communication section (T/R) 53 of the server machine 50.

By thus utilizing the self-development program not only as the dedicated self-development apparatus 1, but also as a self-development system that uses a communication network N, even a user who does not possess the dedicated device or the storage medium in which the self-development program is stored may easily participate in self-development. Self-development without the constraints of time or place becomes possible particularly through the use of a mobile telephone 40c or other wireless terminal device 40, and therefore the development of the user's own abilities can be grate effectively improved.

What is claimed is:

1. A self-development apparatus comprising:
an input means for inputting information about a matter of ideal-state of life including that of user's own seeking ideal-state of life in a determined period of time elapsed from the time at present;
a storage means;
an indication means for indicating information stored in said storage means;
an ideal-state information processing means for executing a routine of storing some of ideal-state information input by said input means into an ideal-state information storage section of said storage means;
a keyword extraction means for extracting a keyword of searching for a specified some of information from among the stored those in said ideal-state information storage section;
a search means for searching of some information about personal ideal-state of life via a communication network by using a certain keyword extracted by said keyword extraction means; and
a data-accumulation means for selecting some of information about a related personal ideal-state of life from among a lot of information collected by means of said search means and accumulating some of relating personal ideal-state-life information in combination with the keyword used in said search of information into a collected-information database storage section of said storage means,
wherein under direction of the control unit of the apparatus that some personal ideal-state-life information specified from among the accumulated relating personal ideal-state-life information are to be indicated on said indication means, the specified relating personal ideal-state-life information are read out from the personal ideal-state-life information database storage section and indicated on said indication means.

2. The self-development apparatus according to claim 1, wherein further information about the user's own history of life including that of the user's own seeking ideal-state of life from the expiration of said determined period of time until the user's death is to be input by the input means and stored in a life-history storage section of the storage means by a personal life-history processing portion thereof.

3. The self-development apparatus according to claim 1, wherein further some information about a matter of the user's own history of life including that of the user's own seeking ideal-state of life before the determined period of time having been elapsed, are to be input by the input means and stored in a life-history storage section of the storage means by a personal life-history processing portion thereof.

4. The self-development apparatus according to claim 1, wherein further information about the user's own history of life from the user's birth up to the present is to be input by the input means and stored in a life-history storage section of the storage means by a personal life-history processing portion thereof.

5. The self-development apparatus according to claim 1, wherein further on one occasion of inputting information about the user's own seeking ideal-state of life, information about a video-graphics and music stored in a computer readable medium is to be output and stored into a video-graphics and music database storage section of the storage means.

6. A self-development system comprising:
at least one or more terminal devices; and
a server machine which is connectable to someone of said terminal devices in interactive communicatory via a communication network, wherein
each one of said terminal devices has:
a first input means for inputting information about a matter of ideal-state of life including that of user's own seeking ideal-state of life in a determined period of time elapsed from the time at present; and
a first indication means for indicating information transferred from said server machine via the communication network,
said server machine has:
a second input means for inputting information about a matter of ideal-state of life including that of user's own seeking ideal-state of life in a determined period of time elapsed from the time at present;
a storage means;
a second indication means for indicating information stored in said storage means;
an ideal-state information processing means for executing a routine of storing some of ideal-state information input by said input means into an ideal-state information storage section of said storage means;
a keyword extraction means for extracting a keyword of searching for a specified some of information from among the stored those in said ideal-state information storage section;
a search means for searching of some information about personal ideal-state of life via a communication network by using a certain keyword extracted by said keyword extraction means; and
a data-accumulation means for selecting some of information about a related personal ideal-state of life from among a lot of information collected by means of said search means and accumulating some of relating personal ideal-state-life information in combination with the keyword used in said search of information into a collected-information database storage section of said storage means,
wherein under direction of the control unit of the apparatus that some personal ideal-state-life information specified from among the accumulated relating personal ideal-state-life information are to be indicated on said indication means, the specified relating personal ideal-state-life information are read out from the personal ideal-state-life information database storage section and indicated on said indication means.

7. The self-development system according to claim 6, wherein further information about the user's own history of life including that of the user's own seeking ideal-state of life from the expiration of said determined period of time until the user's death is to be input by someone of said first and second input means and stored in a life-history storage section of the storage means by a personal life-history processing portion thereof.

8. The self-development system according to claim 6, wherein further some information about a matter of the user's own history of life including that of the user's own seeking ideal-state of life before the determined period of time having been elapsed, are to be input by someone of said first and second input means and stored in a life-history storage section of the storage means by a personal life-history processing portion thereof.

9. The self-development system according to claim 6, wherein further information about the user's own history of life from the user's birth up to the present is to be input by someone of said first and second input means and stored in a life-history storage section of the storage means by a personal life-history processing portion thereof.

10. The self-development system according to claim 6, further on one occasion of inputting information about the user's own seeking ideal-state of life, information about a video-graphics and music stored in a computer readable medium is to be output and stored into a video-graphics and music database storage section of the storage means.

11. A self-development program for implementing the following functional parts comprising:
an ideal-state information processing part which executes a routine of storing some information about a matter of ideal-state of life including that of user's own seeking ideal-state of life in a determined period of time elapsed from the time at present, that is input by an input means on a data inputting step, into an ideal-state information storage section of a storage means;
a keyword extraction part which extracts a keyword to be used to search for a specified some of information from among the stored those in said ideal-state information storage section;
a search part which searches for some information about personal ideal-state of life via a communication network by using a certain keyword extracted by said keyword extraction part;
an accumulation part which selects a specified some of information about a related personal ideal-state of life from among a lot of collected information in the search portion and accumulates some of relating personal ideal-state-life information in combination with the keyword used in said search of information into a collected-information database storage section of said storage means, and
an indication part which indicates information stored in said storage means, wherein under direction of the controlling portion that some relating personal ideal-state-life information specified from among the accumulated relating personal ideal-state-life information are to be indicated on said indication means, the specified relating personal ideal-state-life information are read out from the collected-information database storage section and indicated on the indication means.

12. The self-development program according to claim 11, wherein further information about the user's own history of life including that of the user's own seeking ideal-state of life from the expiration of said determined period of time until the user's death is to be input by the input means and stored in a life-history storage section of the storage means in a personal life-history processing step.

13. The self-development program according to claim 11, wherein further some information about a matter of the user's own history of life including that of the user's own seeking ideal-state of life before the determined period of time having been elapsed, are to be input by the input means and stored in a life-history storage section of the storage means in a personal life-history processing step.

14. The self-development program according to claim 11, wherein further information about the user's own history of life from the user's birth up to the present is to be input by the input means and stored in a life-history storage section of the storage means in a personal life-history processing part.

15. The self-development program according to claim 11, wherein further on one occasion of inputting information about the user's own seeking ideal-state of life, information about a video-graphics and music stored in a computer readable medium is to be output and stored into a video-graphics and music database storage section of the storage means.

16. A computer-readable storage medium that stores a self-development program for implementing functional parts comprising:
an ideal-state information processing part which executes a routine of storing some information about a matter of ideal-state of life including that of user's own seeking ideal-state of life in a determined period of time elapsed from the time at present, that is input by an input means connected with the related computer on a data inputting step, into an ideal-state information storage section of a storage means;
a keyword extraction part which extracts a keyword to be used to search for a specified some of information from among the stored those in said ideal-state information storage section;
a search part which searches for some information about personal ideal-state of life via a communication network by using a certain keyword extracted by said keyword extraction part;
a data-accumulation part which selects a specified some of information about a related personal ideal-state of life from among a lot of collected information in the search portion and accumulates some of relating personal ideal-state-life information in combination with the keyword used in said search of information into a collected-information database storage section of said storage means; and
an indication part which indicates information stored in said storage means, wherein under direction of the controlling portion that some personal ideal-state-life information specified from among the accumulated relating personal ideal-state-life information are to be indicated on said indication means, the specified relating personal ideal-state-life information are read out from the are read out from the collected-information database storage section and indicated on the indication means.
